(19) United States
(12) Patent Application Publication
(10) Pub. No.: US 2024/0202462 A1
(43) Pub. Date: Jun. 20, 2024

(54) Apparatus And Method For Data Augmentation

(71) Applicants: Hyundai Motor Company, Seoul (KR); Kia Corporation, Seoul (KR); New York University, New York, NY (US)

(72) Inventors: Yekyung Kim, Seongnam-Si (KR); Seohyeong Jeong, Suwon-Si (KR); Kyunghyun Cho, New York, NY (US)

(21) Appl. No.: 18/384,122

(22) Filed: Oct. 26, 2023

(30) Foreign Application Priority Data
Dec. 16, 2022 (KR) 10-2022-0177424

(51) Int. Cl. G06F 40/40; G06F 40/284

(52) U.S. Cl. CPC G06F 40/40; G06F 40/284

(57) ABSTRACT

An apparatus for data augmentation includes an encoder configured to encode a plurality of input sentences and output encoded samples based on the plurality of encoded input sentences; a generation part configured to adjust a length of each of the encoded samples to match a target length, and mix the encoded samples having the adjusted length at a predetermined mixing ratio to generate an interpolated hidden vector of a newly generated sentence; and a decoder configured to reconstruct an original sentence corresponding to the interpolated hidden vector.

### CROSS-REFERENCE TO RELATED APPLICATIONS

This application claims the benefit of Korean Patent Application No. 10-2022-0177424, filed on Dec. 16, 2022, the disclosure of which is incorporated herein by reference.

### TECHNICAL FIELD

The disclosure relates to a data augmentation apparatus and data augmentation learning method using the same.

### BACKGROUND

To prevent a machine learning model that has many parameters from being overfit, a large amount of data is required for learning. In addition, obtaining, generating, and categorizing data from external sources may be costly. Therefore, efforts have been made to develop a data augmentation method that generates new data from an original data while preserving the labels of the original data.

Data augmentation is one of the key tools in deep learning when facing domain shift during test time or dealing with low resource scenarios.

A sentence mixing in data augmentation has limitations when applied to natural language processing (NLP), which has discrete and variable-length characteristics. Conventional approaches for applying the sentence mixing to NLP rely on domain-specific heuristics and manually crafted resources such as dictionaries. Rule-based or hand-crafted engineering is mainly proposed when applying the sentence mixing at the hidden-space level or the sentence level.

For example, in NLP, data points (e.g., sentences) have varying lengths. It may be unclear how to interpolate between two data points of different lengths, as some sentences may be longer than others.

Accordingly, before performing the sentence mixing for data augmentation, a shorter sequence is sometimes simply padded to match the length of a longer sequence. However, this conventional method is unclear in terms of what the padding token means, both linguistically or computationally.

In addition, even if a pair of sequences having the same length is given, each token within such sequences are often drawn from a finite set of individual tokens without any intrinsic metric for the tokens.

Other methods have been proposed to augment data by replacing specific words with synonyms, inserting random words, swapping the positions of two words within a sentence, or deleting random words without performing the sentence mixing.

However, these methods cannot consider larger context when replacing each word, and the replacement rules need to be devised manually. In this way, conventional approaches in NLP have proposed methods for applying sentence mixing or augmenting data without performing mixing, but they have several limitations.

### SUMMARY

An aspect of the disclosure is to provide an apparatus and method for data augmentation that are capable of effectively generating qualitatively or quantitatively superior new sentences by mixing input sentences in an unsupervised manner, without requiring heuristic or manually manipulated resources.

According to one or more example embodiments of the present disclosure, an apparatus for data augmentation may include: an encoder configured to encode a plurality of input sentences, and output, based on the plurality of encoded input sentences, encoded samples; a generation part configured to adjust a length of each of the encoded samples to match a target length, and mix the encoded samples having the adjusted length at a predetermined mixing ratio to generate an interpolated hidden vector of a newly generated sentence; and a decoder configured to reconstruct an original sentence corresponding to the interpolated hidden vector.

The encoder may be configured to encode the plurality of input sentences using a byte pair encoding algorithm.

The encoder may be implemented as a bidirectional recurrent neural network or a transformer.

The encoder may be configured to receive each pair of sentences, among the plurality of input sentences, and encode each pair of sentences to output corresponding encoded samples represented as a set of hidden vectors.

The apparatus may further include a masking part configured to replace at least one token, of each of the plurality of input sentences, with a mask token.

The apparatus may further include a noise addition part configured to add a Gaussian noise to the encoded samples.

An original length of each of the plurality of input sentences may remain unaltered while the plurality of input sentences are encoded.

The generation part may be configured to adjust the length of each of the encoded samples based on location-based attention. The generation part may be further configured to: calculate a positional weight of each word in the encoded samples based on a difference in length between a corresponding encoded sample and the target length; apply a softmax function to the positional weight of each word to represent the positional weight of each word as an output value between 0 and 1.0; and sum the output values to obtain a weighed sum of hidden vectors corresponding to the encoded samples.

The generation part may be further configured to linearly combine, according to the predetermined mixing ratio, the encoded samples having the length matched to the target length.

The decoder may be implemented as a recurrent network or a transformer.

The decoder may be configured to reconstruct the original sentence by: receiving the interpolated hidden vector as an input; and reconstructing the original sentence in proportion to the predetermined mixing ratio.

The apparatus may further include a regularization application part configured to obtain a final loss by combining a learning objective function that obtains a loss through a difference between the reconstructed sentence and the original sentence with an L2 loss that applies an L2 regularization to the interpolated hidden vector.

The encoder and the decoder may be further configured to use a pre-learned model including a bidirectional auto-regressive transformer (BART)-large.

The apparatus may further include a classifier configured to perform an inference on the reconstructed sentence; calculate a softmax probability for each label which is used in a classification task based on a result of the inference; and use a label with a highest probability as a correct label for the reconstructed sentence.

According to one or more example embodiments of the present disclosure, a method for data augmentation may include: encoding a plurality of input sentences to output encoded samples; adjusting a length of each encoded samples to match a target length; mixing the encoded samples having the adjusted length at a predetermined mixing ratio to generate an interpolated hidden vector of a newly generated sentence; and reconstructing an original sentence corresponding to the interpolated hidden vector.

The method may further include, before the encoding of each pair of input sentences, replacing at least one word token, of each of the plurality of input sentences, with a mask token.

The method may further include adding a Gaussian noise to the encoded samples.

Adjusting of the length of each encoded samples may include: calculating a positional weight of each word in the encoded samples based on a difference in length between a corresponding encoded sample and the target length; applying a softmax function to the positional weight of each word to represent the positional weight of each word as an output value between 0 and 1.0; and summing the output values to obtain a weighed sum of hidden vectors corresponding to the encoded samples.

Reconstructing the original sentence may include: receiving the interpolated hidden vector as an input; and reconstructing the original sentences in proportion to the predetermined mixing ratio.

The method may further include obtaining a final loss by combining a learning objective function that obtains a loss through a difference between the reconstructed sentence and the original sentence with an L2 loss that applies an L2 regularization to the interpolated hidden vector.

The apparatus and method of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 represents a data augmentation model, referred to as a LINDA model.

FIG. 2 is a block diagram illustrating an apparatus for data augmentation.

FIG. 3 is a flowchart illustrating a method for data augmentation using the apparatus for data augmentation shown in FIG. 2.

FIGS. 4 and 5 represent results of experiments with the data augmentation model, indicating the average unigram precision of interpolated sentences while individually varying the mixing ratio in Wikipedia and TREC.

FIG. 6 is an example table showing interpolated samples.

FIG. 7 is an example table showing comparison between classification accuracy and fine-tuned datasets.

FIG. 8 is an example table showing average accuracy of a model.

### DETAILED DESCRIPTION

Like reference numerals throughout the specification denote like elements. Also, this specification does not describe all the elements according to one or more example embodiments of the disclosure, and descriptions well-known in the art to which the disclosure pertains or overlapped portions are omitted.

It will be understood that when an element is referred to as being “connected” to another element, it may be directly or indirectly connected to the other element, wherein the indirect connection includes “connection” via a wireless communication network.

It will be understood that the term “include” when used in this specification specifies the presence of stated features, integers, steps, operations, elements, and/or components, but does not preclude the presence or addition of at least one other feature, integer, step, operation, element, component, and/or group thereof.

It is to be understood that the singular forms are intended to include the plural forms as well, unless the context clearly dictates otherwise.

The terms such as “˜part,” “˜device,” “˜block,” “˜member”, “˜module,” and the like may refer to a unit for processing at least one function or act. For example, the terms may refer to at least process processed by at least one hardware, such as a field-programmable gate array (FPGA)/application specific integrated circuit (ASIC), software stored in memories or processors.

Reference numerals used for method steps are just used for convenience of explanation, but not to limit an order of the steps. Thus, unless the context clearly dictates otherwise, the written order may be practiced otherwise.

Hereinafter, one or more example embodiments of the disclosure will be described in detail with reference to the accompanying drawings.

The following describes the definition of a sentence interpolation and how the concept of the sentence interpolation is implemented through a neural sequence modeling. The learning objective function and the neural network architecture used for learning are presented.

For example, let's assume that a pair of sentences (also referred to as sequences), x^{a} and x^{b}, have different lengths(L^{a}≠L^{b}) and that each token in the two sentences is included in a finite vocabulary. At this point, x^{a} and x^{b} may be expressed individually as (x₁^{a}, . . . , x_{L}_{^{a}}^{a}) and (x₁^{b}, . . . , x_{L}_{^{b}}^{b}), and the relationship where each token of the sentence is included in a finite vocabulary may be expressed as xᵢ^{a}∈Σ and xⱼ^{b}∈Σ.

The process of generating a new sentence from a conditional probability distribution of Equation 1 using the two sentences described above is defined as the sentence interpolation.

$$p ( y \vert {x}^{a} , {x}^{b} , α ) = {\prod }_{t = 1}^{{L}^{y}} p ( {y}_{t} \vert y < t , {x}^{a} , {x}^{b} , α ) \qquad [ Equation 1 ]$$

In the Equation 1 above, α∈[0.1] represents a mixing ratio, and L^{y} represents the length of a sentence y. Applying the mixing ratio α to a pair of sentences x^{a} and x^{b} generates the sentence y as an output, and higher probabilities of generating such output indicate superior learning performance.

Specifically, the sentence y is generated by the sentence interpolation. Depending on the length of the sentence y, tokens may be drawn one by one from the conditional probability distribution, resulting in the sentence y as the output.

A pair of input sentences are mixed according to the mixing ratio to generate a new sentence, and the generated sentence is restored to be similar to the original pair of sentences. The probability of restoring the sentence to be similar to the original pair of sentences may be controlled by the mixing ratio α.

In the process of receiving a pair of input sentences x^{a} and x^{b} and generating the sentence y, the learning is optimized such that the difference between the conditional probability distribution of Equation 4 and the conditional probability distribution of Equation 1 is not significant. Thus, Equation 1 may be used as an evaluation metric for the learning method.

An unsupervised learning approach is proposed for performing the sentence interpolation for the purpose of the data augmentation, which is defined as learning to interpolate for data augmentation (LINDA).

The LINDA is a conditional language model for the data augmentation, implemented by an apparatus 100 for data augmentation. Unlike conventional techniques that require heuristic or manually manipulated resources, the LINDA performs learning for the sentence interpolation between any pairs of natural language sentences without any heuristic or a manual manipulation.

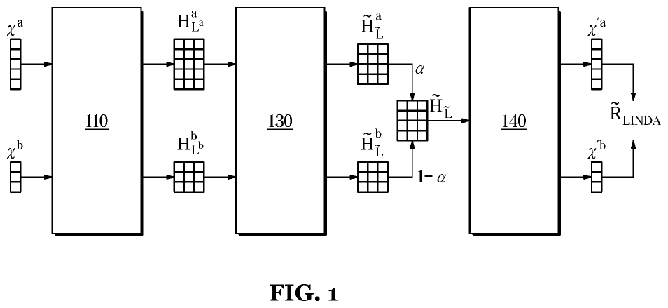

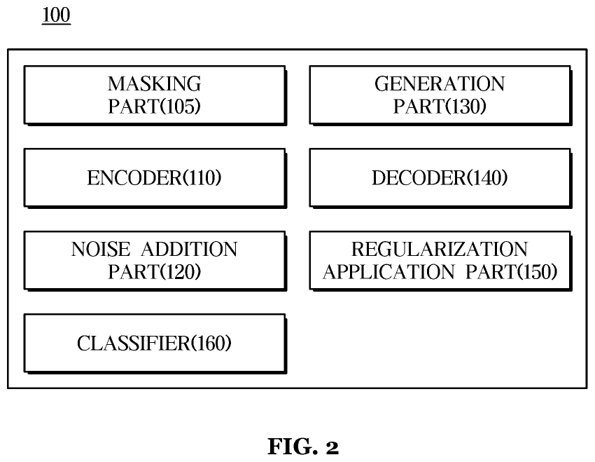

FIG. 1 represents a data augmentation model, referred to as a LINDA model, and FIG. 2 is a block diagram illustrating an apparatus for data augmentation.

Referring to FIGS. 1 and 2, the LINDA uses an encoder and a decoder architecture of a sequence-to-sequence (Seq2Seq) model.

The definition of the sentence interpolation may be expressed as Equation 1 because we do not know the answer to which sentence should be generated if a pair of sentences x^{a} and x^{b} are mixed with a weight of the mixing ratio α.

However, parameterization may be performed with Equation 4, as described later. Parameterization is the process of defining parameters to enable a neural network to learn the process of creating a new sentence y by mixing two sentences.

The sentence interpolation may be performed while preserving the attributes of the original sentences, and the LINDA may be learned using an unsupervised learning approach without using labeled tokens such as positive or negative.

For this purpose, the apparatus for data augmentation 100 includes an encoder 110, a masking part 105, a noise addition part 120, a generation part 130, a decoder 140, a regularization application part 150, and a classifier 160. After learning the LINDA model, actual data augmentation tasks are performed.

The encoder 110 receives a plurality of input sentences and outputs encoded samples to the generator 130. In this case, the encoder 110 can receive pairs of sentences (also referred to as sequences) as input and output encoded samples.

For example, a pair of sentences x^{a} and x^{b} are each input to the encoder 110, which outputs encoded samples, i.e., hidden vectors. Passing through the encoder 110, a pair of sentences generates hidden vectors equal to the number of tokens.

The input values to the encoder 110 are individual tokens representing sentences, which may be expressed as x=(x₁, . . . x_{L})∈Σ^{L}. Herein, Σ is a finite set of unique tokens, and L varies from one sample to another sample.

The encoder 110 is implemented as a bidirectional recurrent neural network or a transformer.

The encoder 110 is configured to encode an input value using a byte pair encoding (BPE) algorithm. Byte pair encoding is an information compression algorithm that compresses data by merging the most frequently occurring substrings in the data.

The encoder 110 receives each pair of sentences among a plurality of input sentences and encodes the pair of sentences to output the encoded samples represented as a set of hidden vectors. Referring to FIG. 1, the output values may be represented as encoded samples such as H^{a}={h₁^{a}, . . . , h_{L}_{^{a}}^{a}} and H^{b}={h₁^{b}, . . . , h_{L}_{^{b}}^{b}}.

In this case, as each word token in a sentence has a hidden vector, a pair of sentences with different lengths will result in each having a different number of hidden vectors after passing through the encoder 110.

The original length of the input sentence is preserved during the NLP processing. For example, if the length of the input sentence was 10, it may be represented as a hidden vector of length 10. The encoder 110 generates a matrix of size 10*(dimension of hidden vector) as output. Consequently, the original length of the input sentence is maintained as the first dimension of the hidden vector matrix, allowing the preservation of the original length of the input sentence.

The masking part 105 replaces at least one or more words in each sentence with mask tokens before inputting them into the encoder 110. For example, the masking part 105 can randomly apply word-level masking to some words in each sentence. This is done to replace some words in the sentence with mask tokens, allowing for the reconstruction of masked information during the LINDA learning, and enabling the model to learn contextual information.

The masking part 105 can randomly mask each word in a sentence using a masking probability, which determines the number of words to be replaced with the <MASK> token in the entire sentence. The sentence with some words replaced by mask tokens is then inputted into the encoder 110 for encoding.

The noise addition part 120 adds Gaussian noise to the hidden vector output by the encoder 110.

The noise addition part 120 can add Gaussian noise with a very small value of mean 0 (zero) to each hidden vector.

The generation part 130 uniformly adjusts the lengths of the samples encoded by the encoder 110. The generation part 130 can use location-based attention to adjust the lengths of each encoded sample (i.e., hidden vector) in order to match the target length.

Specifically, when reducing a sentence with a length of 10 words to 5 words, the difference between the target length and the length of the sentence is set as the distance value. Then, weights based on the distance values (i.e., positions) of each word in the sentence are applied to the softmax function, and the output values calculated by the softmax are summed to obtain the weighted sum of hidden vectors output from the encoder 110.

The target length (\tilde{L}) mentioned above may be defined as Equation 2.

$$\tilde{L} = ⌈ α {L}^{a} + ( 1 - α ) {L}^{b} ⌉ \qquad [ Equation 2 ]$$

In Equation 2, L^{a} and L^{b} represent interpolated values, and the lengths of samples represented by the set of hidden vectors output from the encoder 110 are adjusted to match the target length \tilde{L}, resulting in \tilde{H}^{a}={\tilde{h}₁^{a}, . . . , \tilde{h}_{\tilde{L}}^{a}} and \tilde{H}^{b}={\tilde{h}₁^{b}, . . . , \tilde{h}_{\tilde{L}}^{b}}.

Thus, the hidden vector set output from the encoder 110 is down-sampled or up-sampled to match the target length \tilde{L}. Herein, each of the \tilde{h} is defined as the weighted sum of hidden vectors output from the encoder 110, as shown in Equation 3.

$${\tilde{h}}_{j} = {\sum }_{k = 1}^{L} {w}_{k}^{j} {h}_{k} \qquad [ Equation 3 ]$$

In Equation 3, wₖ^{j} may be represented as

$${w}_{k}^{j} = {e}^{{a}_{k}^{j}} / {\sum }_{{k}^{′} = 1}^{L} {e}^{{a}_{{k}^{′}}^{j}} ,$$

which is a weight calculated based on the location-based attention.

The generation part 130 calculates the position-based weights for each word of the samples (i.e. hidden vectors) encoded by the encoder 110, based on the difference between the current length of the samples and the target length. These calculated position-based weights are then applied to a softmax function to obtain output values between 0 (zero) and 1.0, which are then summed to obtain the weighted sum of hidden vectors output from the encoder 110.

Furthermore, the generation part 130 applies the designated mixing ratios to each sample, which has been adjusted for the target length, to mix them accordingly and generate interpolated hidden vectors for the newly generated sentence. In this process, the generation part 130 can linearly combine the samples according to the designated mixing ratios. Linear combination refers to linearly combining the hidden vector corresponding to sentence x^{a} with a weight of α, and the hidden vector corresponding to sentence x^{b} with a weight of 1−α.

The interpolated hidden vector may be expressed as \tilde{H}={\tilde{h}₁, . . . , \tilde{h}_{\tilde{L}}}, and it may be obtained by \tilde{h}ᵢ=α\tilde{h}ᵢ^{a}+(1−α)\tilde{h}ᵢ^{b} to which the previously mentioned mixing ratio is applied.

The decoder 140 may reconstruct the original sentences from each source sentence proportionally based on the interpolated hidden vector received from the generation part 130, according to the mixing ratios applied to each original sentence. In other words, the mixing ratios that were applied to each sample may be directly applied to x^{a} and x^{b} to reconstruct the original sentences.

The decoder 140 may be implemented as a recurrent network or a transformer having a causal attention.

The decoder 140 takes the interpolated hidden vector set \tilde{H} as input from the generation part 130 and reconstructs the original sentence according to the configured mixing ratio, ensuring that the output values (i.e. answers) follow the conditional probability distribution of Equation 1. In this process, an autoregressive method may be used to predict future tokens from the current or previous tokens (i.e. data).

On the other hand, the learning objective function of the LINDA may be defined as Equation 4 below.

$${LINDA}_{} = - \frac{1}{M} {\sum }_{m = 1}^{M} α log p ( {x}^{a , m} \vert {x}^{a , m} , {x}^{b , m} , {α}^{m} ) + ( 1 - α ) log p ( {x}^{b , m} \vert {x}^{a , m} , {x}^{b , m} , {α}^{m} ) \qquad [ Equation 4 ]$$

In Equation 4, M represents the number of pairs of input sentences during learning, and α log p(x^{a,m}|x^{a,m}, x^{b,m}, α^{m})+(1−α)log p(x^{b,m}|x^{a,m}, x^{b,m}, α^{m}) is a conditional probability distribution that may be used to reconstruct the original sentence x^{a} based on a log p(x^{a,m}|x^{a,m}, x^{b,m}, α^{m}) from the pair of sentences x^{a} and x^{b}, and to reconstruct the original sentence x^{b} based on (1−α)log p(x^{b,m}|x^{a,m}, x^{b,m}, α^{m}).

In this context, the contribution of two sentences in reconstructing the original sentence may be adjusted using the probability ratio α as a parameter. Specifically, when reconstructing the original sentence x^{a}, a weight of α is assigned, while a weight of 1−α is assigned during the process of reconstructing the original sentence x^{b}.

Furthermore, the conditional probability distribution of Equation 4 is transformed and used through cross entropy, and the logarithm function is used for performing the cross entropy.

The reconstructed sentences x^{′a} and x^{′b} by decoder 140 are predicted values of the reconstructed sentences that are as close as possible to the original sentences. The difference between the predicted values obtained from Equation 4 and the output values according to the conditional probability distribution of Equation 1 may be calculated as the loss. In other words, the difference between the reconstructed sentences and the original sentences may be determined by the learning objective function.

Furthermore, the weight α is used for each sentence when generating a new sentence by mixing two sentences. Since it is a question of how much x^{a} and x^{b} should be reflected in generating the new sentence, the range of α may be limited to 0 (zero) to 1.

In addition, a learning data with M randomly sampled pairs within the range of α˜ [symbol] (0, 1) can be extracted as mini-batches of small sizes for learning. [symbol] (0,1) represent a uniform distribution in the set [0,1], which means random values are sampled between 0 and 1. The reason for using randomly sampled values is to learn the model efficiently to perform sentence interpolation regardless of the given weight.

The regularization application part 150 obtains a final loss by combining a learning objective function that obtains a loss through a difference between the reconstructed sentence and the original sentence with a L2 loss that applies L2 regularization to the interpolated hidden vector.

Through this, it is possible to guide the weights of the hidden vectors to converge using a ridge regression model.

It is possible to perform learning of the LINDA model using millions of randomly sampled sentence pairs from Wikipedia.

In addition, the pre-learned model, a bidirectional auto-regressive transformer (BART)-large, can be applied to the LINDA model.

The BART is a transformer-based encoder/decoder model that is pre-trained as a denoising autoencoder. The BART has an autoregressive decoder, which allows for fine-tuning. If input values are given to the encoder, the BART generates output values autoregressively in the decoder.

In the learning process, to train the learning data with small-sized minibatches, a random mixing ratio can be set using α∈[0,1]. The weight α represents the ratio at which two sentences are mixed. The weight can be randomly sampled from values between 0 and 1. The reason for using random values instead of fixed values is to provide various cases to the LINDA model during learning, so that a pair of sentences can be mixed proportionally to the weights.

In addition, the batch size can be set to 8, and the Adam optimizer (Kingma and Ba, 2015) with a fixed learning rate 1e⁻⁵ can be used. The batch size refers to the number of pairs of data included in one batch.

In addition, 8 GPUs (Tesla T4) may be used for learning.

In addition, the word-level masking may be applied to input sentences with a masking probability set to 0.1.

In addition, by using a beam search (beam size 4), a new sentence can be generated by iterating through each step until the last token of the sentence is reached. In beam search, the search space is maintained with the k most likely tokens at each step, and the next step is explored. Herein, k is a hyper-parameter specified by the user.

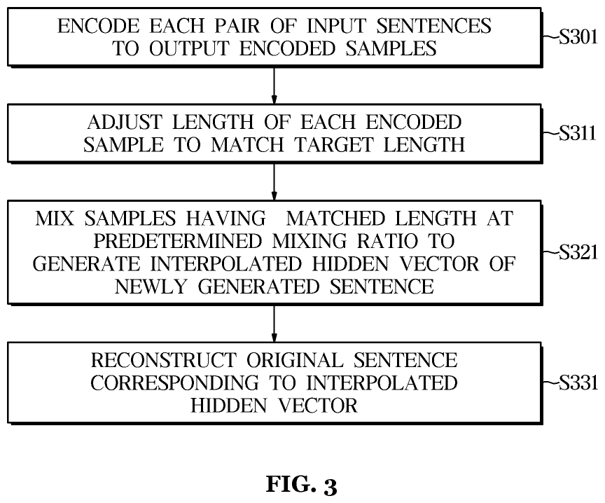

FIG. 3 is a flowchart illustrating a method for data augmentation using the apparatus for data augmentation shown in FIG. 2.

First, the encoder 110 encodes each pair of input sentences to output encoded samples (S301).

At this point, a process may be performed to replace some words of each sentence with mask tokens before the encoding step S301. In addition, after the encoding step S301, a process may be performed to add Gaussian noise to the encoded samples.

Next, the generation part 130 adjusts the length of each encoded sample to match the target length (S311). The adjusting a length of each encoded samples to match a length of a target length may include calculating a positional weight of each word in the encoded samples based on a difference in length between each of the encoded samples and the length of the target length, applying the positional weight of each word to softmax to represent the positional weight of each word as an output value between 0 and 1.0, and summing the output values to obtain a weighed sum of hidden vectors output from the encoder 110.

Next, in the generation part 130, samples with matched lengths are mixed at a predetermined mixing ratio to generate an interpolated hidden vector (S321).

Then, the decoder 140 receives the interpolated hidden vector and reconstructs each original sentence (S331). Herein, during the process of reconstructing each original sentence from an interpolated hidden vector, each original sentence can be reconstructed proportionally to the mixing ratio applied to it. In addition, a process may be performed to obtain a final loss by combining a learning objective function that obtains a loss through a difference between the reconstructed sentence and the original sentence with a L2 loss that applies L2 regularization to the interpolated hidden vector.

Hereinafter, the process of performing actual data augmentation using the learned LINDA is described. For data augmentation, a pair of data is selected from the target data, and a mixing ratio to be applied to it is set. The target data represents the base data for performing data augmentation.

Next, the LINDA model generates a new interpolated sentence by mixing the given data pairs in the specified mixing ratio. In order to use the interpolated sentence for a specific classification task, the correct label is required. The existing classifier 160 learned with target data receives the newly generated sentence (interpolated hidden vector) from the generation part 130 as input, performs inference, and calculates softmax probabilities for each label to be used in the classification task. The label with the highest softmax probability is used as the correct label for the newly generated sentence.

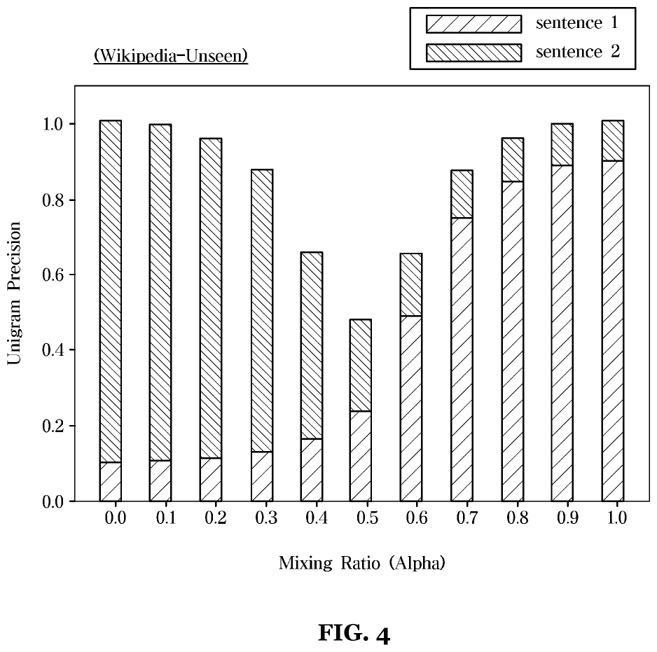

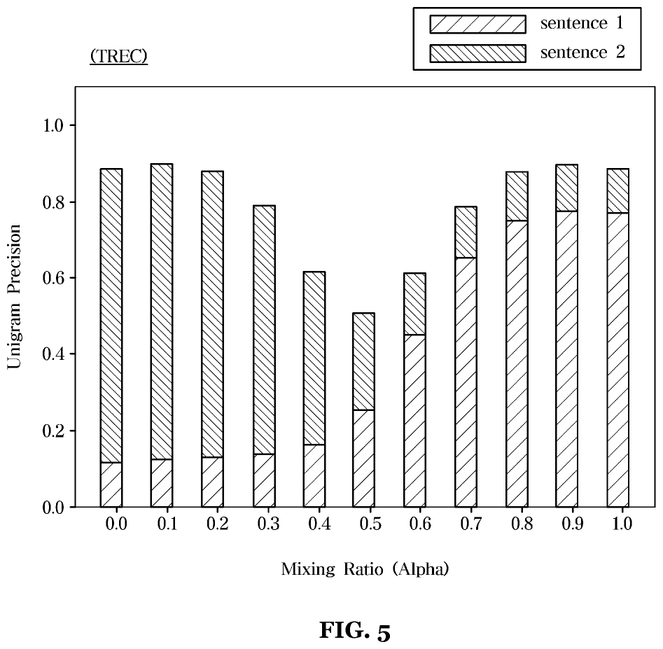

FIGS. 4 and 5 represent results of experiments with the data augmentation model, indicating the average unigram precision of interpolated sentences while individually varying the mixing ratio in Wikipedia and TREC.

As shown in FIGS. 4 and 5, the unigram precision shows a monotonous tendency during the change in mixing ratio from 0.0 to 1.0. It decreases for the first original sentence (sentence 1) and increases for the second original sentence (sentence 2).

The LINDA successfully reconstructed one of the original sentences with an excessive mixing ratio, and the unigram precision score is close to 1.

As the mixing ratio approaches 0.5, the interpolated sentence deviates greatly from the two input sentences as expected.

The interpolated sentences generated through the LINDA maintain a very good form, indicating that it can perform sentence interpolation excellently across various natural languages.

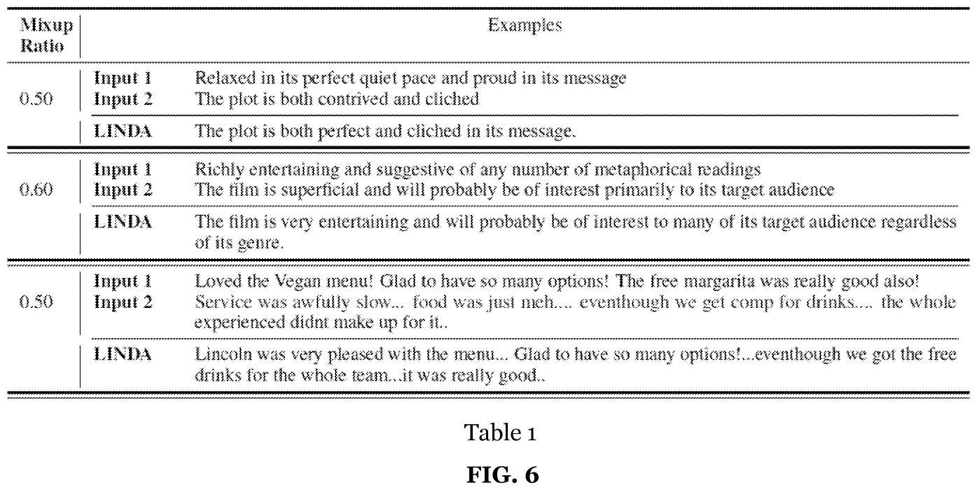

FIG. 6 is an example table showing interpolated samples. The Table 1 shows the interpolated samples using randomly sampled pairs from SST-2 (Scher et al., 2013) and Yelp.

As expected from the aforementioned unigram precision, most of the interpolated sentences in the first and third examples show a slight mix of semantic and syntactic structures from the pair of original sentences with the applied mixing ratio.

The second example demonstrates that LINDA performs well not only in paraphrasing but also in synonyms. This indicates that LINDA generates new sentences with correct forms very well.

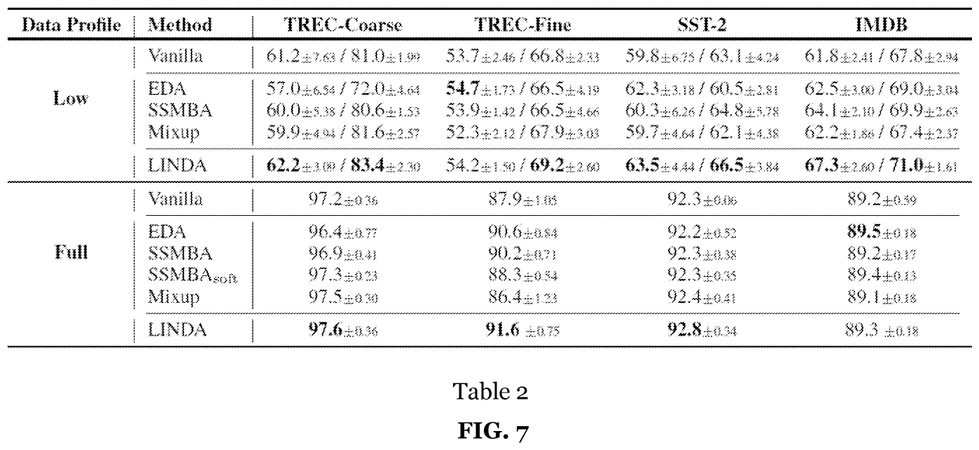

FIG. 7 is an example table showing comparison between classification accuracy and fine-tuned datasets. The table above Table 2 compares the classification accuracy (%) of the BERT-base model after performing data augmentation and fine-tuning on four datasets under different resource settings (5-shot/10-shot). All results are reported as “mean (±std)”.

Under the low-resource setting, LINDA shows better performance than other data augmentation methods (EDA, SSMBA, SSMBAsoft). Moreover, under the full-resource setting, LINDA outperforms other data augmentation methods on all datasets except IMDB.

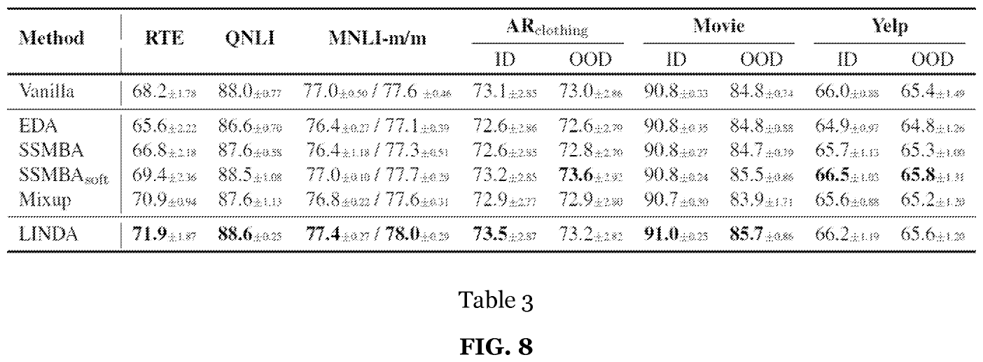

FIG. 8 is an example table showing average accuracy of a model. The Table 3 shows the average evaluation accuracy (%) of BERT-base. The first three columns indicate the accuracy of NLI datasets. The next three columns indicate the accuracy in ID (In-Distribution) and OOD (Out-Of-Distribution) settings with ARclothing, Movie, and Yelp datasets. All results are reported as “mean (±std)”.

Looking at the Table 3, LINDA shows superior performance compared to other data augmentation methods (EDA, SSMBA, SSMBAsoft) in RTE, QNLI, and MNLI. LINDA improved evaluation accuracy compared to other data augmentation methods by 5.4% in RTE, 0.7% in QNLI, and 0.5% in MNLI. In addition, LINDA demonstrates good performance in both ID and OOD settings.

One or more example embodiments of the disclosure have thus far been described with reference to the accompanying drawings. It should be apparent to those of ordinary skill in the art that the disclosure may be practiced in other forms than the embodiments as described above without changing the technical idea or essential features of the disclosure. The above embodiments are only by way of example, and should not be interpreted in a limited sense.

What is claimed is:

1. An apparatus for data augmentation, the apparatus comprising:
an encoder configured to:
encode a plurality of input sentences; and
output, based on the plurality of encoded input sentences, encoded samples;
a generation part configured to:
adjust a length of each of the encoded samples to match a target length; and
mix the encoded samples having the adjusted length at a predetermined mixing ratio to generate an interpolated hidden vector of a newly generated sentence; and
a decoder configured to reconstruct an original sentence corresponding to the interpolated hidden vector.

2. The apparatus of claim 1, wherein the encoder is configured to encode the plurality of input sentences using a byte pair encoding algorithm.

3. The apparatus of claim 1, wherein the encoder is implemented as a bidirectional recurrent neural network or a transformer.

4. The apparatus of claim 1, wherein the encoder is configured to receive each pair of sentences, among the plurality of input sentences, and encode the each pair of sentences to output corresponding encoded samples represented as a set of hidden vectors.

5. The apparatus of claim 1, further comprising:
a masking part configured to replace at least one token, of each of the plurality of input sentences, with a mask token.

6. The apparatus of claim 1, further comprising:
a noise addition part configured to add a Gaussian noise to the encoded samples.

7. The apparatus of claim 1, wherein an original length of each of the plurality of input sentences remains unaltered while the plurality of input sentences are encoded.

8. The apparatus of claim 1, wherein the generation part is configured to adjust the length of each of the encoded samples based on location-based attention, and
wherein the generation part is further configured to:
calculate a positional weight of each word in the encoded samples based on a difference in length between a corresponding encoded sample and the target length;
apply a softmax function to the positional weight of each word to represent the positional weight of each word as an output value between 0 and 1.0; and
sum the output values to obtain a weighed sum of hidden vectors corresponding to the encoded samples.

9. The apparatus of claim 1, wherein the generation part is further configured to linearly combine, according to the predetermined mixing ratio, the encoded samples having the length matched to the target length.

10. The apparatus of claim 1, wherein the decoder is implemented as a recurrent network or a transformer.

11. The apparatus of claim 1, wherein the decoder is configured to reconstruct the original sentence by:
receiving the interpolated hidden vector as an input; and
reconstructing the original sentence in proportion to the predetermined mixing ratio.

12. The apparatus of claim 1, further comprising:
a regularization application part configured to obtain a final loss by combining a learning objective function that obtains a loss through a difference between the reconstructed sentence and the original sentence with an L2 loss that applies an L2 regularization to the interpolated hidden vector.

13. The apparatus of claim 1, wherein the encoder and the decoder are further configured to use a pre-learned model comprising a bidirectional auto-regressive transformer (BART)-large.

14. The apparatus of claim 1, further comprising:
a classifier configured to perform an inference on the reconstructed sentence;
calculate a softmax probability for each label which is used in a classification task based on a result of the inference; and
use a label with a highest probability as a correct label for the reconstructed sentence.

15. A method for data augmentation, the method comprising:
encoding a plurality of input sentences to output encoded samples;
adjusting a length of each encoded samples to match a target length;
mixing the encoded samples having the adjusted length at a predetermined mixing ratio to generate an interpolated hidden vector of a newly generated sentence; and
reconstructing an original sentence corresponding to the interpolated hidden vector.

16. The method of claim 15, further comprising:
before the encoding of each pair of input sentences, replacing at least one word token, of each of the plurality of input sentences, with a mask token.

17. The method of claim 15, further comprising:
adding a Gaussian noise to the encoded samples.

18. The method of claim 15, wherein the adjusting of the length of each encoded samples comprises:
calculating a positional weight of each word in the encoded samples based on a difference in length between a corresponding encoded sample and the target length;
applying a softmax function to the positional weight of each word to represent the positional weight of each word as an output value between 0 and 1.0; and
summing the output values to obtain a weighed sum of hidden vectors corresponding to the encoded samples.

19. The method of claim 15, wherein the reconstructing the original sentence comprises:
receiving the interpolated hidden vector as an input; and
reconstructing the original sentences in proportion to the predetermined mixing ratio.

20. The method of claim 15, further comprising:
obtaining a final loss by combining a learning objective function that obtains a loss through a difference between the reconstructed sentence and the original sentence with an L2 loss that applies an L2 regularization to the interpolated hidden vector.
